(19) United States
(12) Patent Application Publication
(10) Pub. No.: US 2020/0216663 A1
(43) Pub. Date: Jul. 9, 2020

(54) ARTICLES MADE FROM HIGH HEAT, HIGH IMPACT POLYCARBONATE COMPOSITIONS AND METHOD OF MANUFACTURE

(71) Applicant: SABIC GLOBAL TECHNOLOGIES B.V., Bergen op Zoom (NL)

(72) Inventor: Tony FARRELL, Bergen op Zoom (NL)

(21) Appl. No.: 16/731,350

(22) Filed: Dec. 31, 2019

(30) Foreign Application Priority Data
Jan. 4, 2019 (EP) 19150307.7

(51) Int. Cl. C08L 69/00; C08G 64/04; C08L 83/04; C08K 5/00; C08K 5/42; C08K 3/24; C08K 3/105; C08K 7/14; C08K 5/524; C08K 9/10; C08L 25/12; C08L 27/18; C08K 5/10; C08K 5/3472

(52) U.S. Cl. CPC C08L 69/00; C08L 2205/035; C08L 83/04; C08K 5/005; C08K 5/0066; C08K 5/42; C08K 3/24; C08K 3/105; C08K 7/14; C08K 5/524; C08K 9/10; C08L 25/12; C08L 27/18; C08K 5/10; C08K 5/3472; C08L 2201/02; C08L 2201/08; C08L 2203/16; C08L 2203/20; C08L 2203/30; C08G 64/04

(57) ABSTRACT

An article comprising a polycarbonate composition is disclosed, wherein a molded sample of the polycarbonate composition has a Vicat B120 softening temperature of at least 150° C. as measured according to ISO 306, an Izod notched impact strength of greater than or equal to 10 kiloJoule per square meter as measured at 23° C. according to ISO 180/1 A, and a flame test rating of V1 as measured according to UL-94 at 0.8 millimeter and 1.2 millimeter thickness, preferably V0 at 1.2 millimeter thickness.

### CROSS-REFERENCE TO RELATED APPLICATION

This application claims priority to European Patent Application No. 19150307.7, filed on Jan. 4, 2019, and all the benefits accruing therefrom under 35 U.S.C. § 119, the content of which in its entirety is herein incorporated by reference.

### BACKGROUND

This disclosure is directed to articles comprising polycarbonate compositions, specifically glass filled, high heat, high impact polycarbonate compositions and their method of manufacture.

Materials used for electrical applications can require high heat resistance, high impact strength, and good flammability properties. The market is also moving towards articles having thin walls for purposes of weight and size reduction, for example. Polycarbonates have been used in the manufacture of articles and components for a wide range of applications, from automotive parts to electronic appliances. Polycarbonates generally have low heat resistance but good impact strength.

There is a need for polycarbonate compositions that have high heat resistance, good impact strength, and good flammability properties in articles having thin wall thicknesses.

### SUMMARY

An article is provided, comprising a polycarbonate composition, the composition comprising up to 60 wt % of a bisphenol A homopolycarbonate composition comprising a bisphenol A homopolycarbonate having a weight average molecular weight from 15,000-40,000 grams/mole as measured via gel permeation chromatography using bisphenol A homopolycarbonate standards; 7-30 wt % of a poly(carbonate-siloxane); 10-70 wt %, preferably 10-50 wt % of a high heat copolycarbonate having a glass transition temperature of 170° C. or higher as determined per ASTM D3418 with a 20° C./min heating rate; 0.05-0.7 wt % of a flame retardant salt; 5-45 wt % of glass fibers; 0.25-0.9 wt %, preferably 0.3-0.6 wt %, of an anti-drip agent; and optionally, up to 10 wt % of an additive composition, wherein each amount is based on the total weight of the polycarbonate composition, which sums to 100 wt %; and wherein a molded sample of the polycarbonate composition has a Vicat B120 softening temperature of at least 150° C. as measured according to ISO 306, an Izod notched impact strength of greater than or equal to 10 kiloJoule per square meter as measured at 23° C. according to ISO 180/1 A, and a flame test rating of V1 as measured according to UL-94 at 0.8 millimeter (mm) and 1.2 mm thickness, preferably V0 at 1.2 mm.

A method for forming an article comprising the above-described polycarbonate composition is provided, the method comprising molding, casting, or extruding the article.

The above described and other features are exemplified by the following detailed description, examples, and claims.

### DETAILED DESCRIPTION

The inventors hereof have discovered a polycarbonate composition having all three of high heat resistance, high impact strength, and good flammability properties that are especially useful in thin-walled articles. The polycarbonate composition comprises a bisphenol A homopolycarbonate composition, a high heat copolycarbonate, a poly(carbonate-siloxane), a flame retardant salt, an anti-drip agent, and glass fibers. The polycarbonate composition can be used to prepare a wide variety of articles, including thin-walled articles. The polycarbonate composition provides a combination of the desired heat resistance, impact strength, and flammability properties for thin-walled articles, particularly for articles having a wall thickness of less than 1.5 mm. A molded sample of the polycarbonate composition has a Vicat B120 softening temperature of at least 150° C., preferably from 155-165° C. as measured according to ISO 306, an Izod notched impact strength of greater than or equal to 10 kilojoule (kJ) per square meter (m²) as measured at 23° C. according to ISO 180/1 A, and a flame test rating of V1 as measured according to UL-94 at 0.8 mm and 1.2 mm thickness, and preferably of V0 at 1.2 mm.

The polycarbonate composition comprises three different types of polycarbonate, a bisphenol A homopolycarbonate composition, a high heat copolycarbonate having a glass transition temperature of 170° C. or higher as determined per ASTM D3418 with a 20° C./min heating rate, and a poly(carbonate-siloxane).

“Polycarbonate” as used herein means a homopolymer or copolymer having repeating structural carbonate units of formula (1)

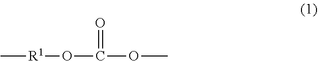

wherein at least 60 percent of the total number of R¹ groups are aromatic, or each R¹ contains at least one C₆₋₃₀ aromatic group.

In the bisphenol A homopolycarbonate, each R¹ in formula (1) is a unit derived from bisphenol A or a derivative thereof. The bisphenol A homopolycarbonate composition can be a single bisphenol A homopolycarbonate having a weight average molecular weight (Mw) of 15,000-40,000 grams/mole (g/mol), or 20,000-40,000 g/mol, or 15,000-40,000 g/mol, each as measured by gel permeation chromatography (GPC), using a crosslinked styrene-divinylbenzene column and calibrated to bisphenol A homopolycarbonate references. GPC samples are prepared at a concentration of 1 milligram (mg) per milliliter (ml) and are eluted at a flow rate of 1.5 ml per minute. In an aspect, the bisphenol A homopolycarbonate is a linear homopolymer containing bisphenol A carbonate units (BPA-PC), commercially available under the trade name LEXAN from SABIC.

The bisphenol A homopolycarbonate composition can include two or more bisphenol A homopolycarbonates. For example, the bisphenol A homopolycarbonate composition can include a first bisphenol A homopolycarbonate and a second bisphenol A homopolycarbonate that is different from the first bisphenol A homopolycarbonate. In a particular aspect, the first bisphenol A homopolycarbonate can have a weight average molecular weight of 20,000-30,000 g/mol, preferably 20,000-25,000 g/mol and the second bisphenol A homopolycarbonate can have a weight average molecular weight of 25,000-35,000 g/mol, preferably 27,000-32,000 g/mol, wherein Mw can be measured by GPC as described above.

The bisphenol A polycarbonate homopolymers can have an intrinsic viscosity, as determined in chloroform at 25° C., of 0.3-1.5 deciliters per gram (dl/gm), or 0.45-1.0 dl/gm.

“Polycarbonates” as used herein further includes copolymers comprising different R¹ moieties in the carbonate units of formula (1) (“copolycarbonates”), and copolymers comprising carbonate units of formula (1) and other types of polymer units, such as siloxane units.

In the high heat copolycarbonate, each R¹ is the same or different, provided that the R¹ groups include (a) a C₆₋₁₆ low heat divalent aromatic group derived from a low heat monomer, and (b) a C₁₇ or higher divalent group derived from a high heat monomer as further described below. In an aspect, R¹ each independently consists essentially, or consists of, (a) a bisphenol A divalent group and (b) a C₁₇ or higher divalent group derived from a high heat monomer as further described below.

The low heat bisphenol group can be of formula (2)

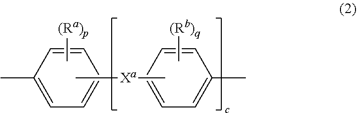

wherein R^{a} and R^{b} are each independently a halogen, C₁₋₃ alkoxy, or C₁₋₃ alkyl, c is 0 or 1, and p and q are each independently integers of 0 or 1. In an aspect, p and q is each 0, or p and q is each 1 and R^{a} and R^{b} are each a methyl, disposed meta to the bond on each arylene group. X^{a} in formula (2) is a bridging group connecting the two aromatic groups, where the bridging group and the bonds of each C₆ arylene group are disposed ortho, meta, or para (preferably para) to each other on the C₆ arylene group, for example, a single bond, —O—, —S—, —S(O)—, —S(O)₂—, —C(O)—, or a C₁₋₆ organic group, which can be cyclic or acyclic, aromatic or non-aromatic, and can further comprise heteroatoms such as halogens, oxygen, nitrogen, sulfur, silicon, or phosphorous. For example, X^{a} can be a C₃₋₆ cycloalkylene, a C₃₋₆ cycloalkylidene, a C₁₋₆ alkylidene of the formula —C(R^{c})(R^{d})— wherein R^{c} and R^{d} are each independently hydrogen, C₁₋₅ alkyl, or a group of the formula —C(═R^{e})— wherein R^{e} is a divalent C₁₋₅ hydrocarbon group. Some illustrative examples of dihydroxy compounds that can be used as the low heat monomer are described, for example, in WO 2013/175448 A1, US 2014/0295363, and WO 2014/072923.

In an aspect, the low heat monomer is bisphenol A, which provides the low heat group of formula (2a).

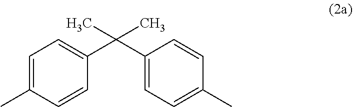

The high heat bisphenol group is derived from a high heat bisphenol monomer having at least 19 carbon atoms. As used herein, a high heat bisphenol monomer is a monomer where the corresponding homopolycarbonate of the monomer has a glass transition temperature (Tg) of 155° C. or higher as determined per ASTM D3418 with a 20° C./min heating rate.

Examples of such high heat bisphenol groups include groups of formulas (3)-(9).

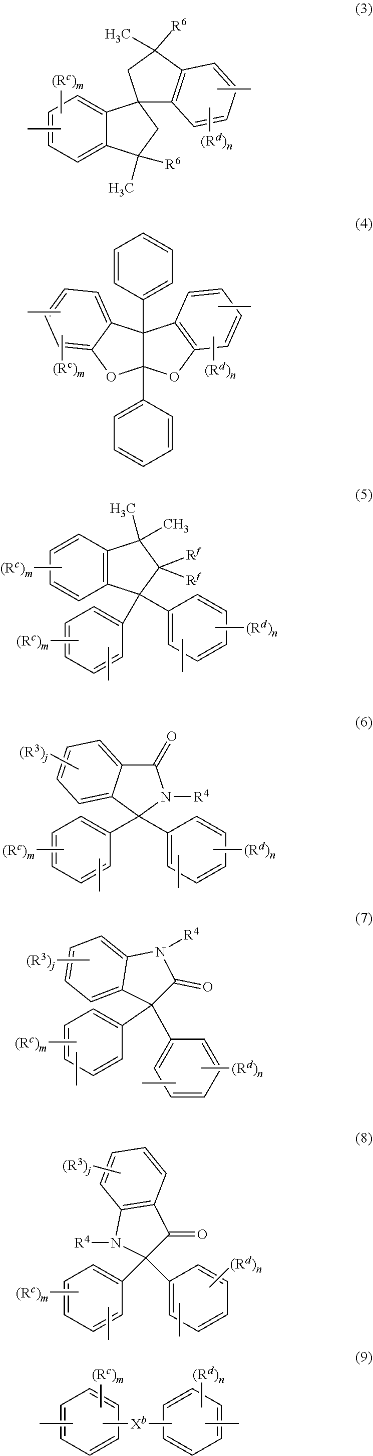

wherein R^{c} and R^{d} are each independently a C₁₋₁₂ alkyl, C₂₋₁₂ alkenyl, C₃₋₈ cycloalkyl, or C₁₋₁₂ alkoxy, each R^{f} is hydrogen or both R_{f} together are a carbonyl group, each R³ is independently C₁₋₆ alkyl, R⁴ is hydrogen, C₁₋₆ alkyl, or phenyl optionally substituted with 1 to 5 C₁₋₆ alkyl groups, R⁶ is independently C₁₋₃ alkyl, or phenyl, preferably methyl, X^{b} is a C₆₋₁₂ polycyclic aryl, C₃₋₁₈ mono- or polycycloalkylene, C₃₋₁₈ mono- or polycycloalkylidene, —C(R^{f})(R^{g})— wherein R^{f} is hydrogen, C₁₋₁₂ alkyl, or C₆₋₁₂ aryl and R^{g} is C₆₋₁₀ alkyl, C₆₋₈ cycloalkyl, or C₆₋₁₂ aryl, or -(Q^{a})ₓ-G-(Q^{b})_{y}- group, wherein Q^{a} and Q^{b} are each independently a C₁₋₃ alkylene, G is a C₃₋₁₀ cycloalkylene, x is 0 or 1, and y is 0 or 1, and j, m, and n are each independently 0 to 4. A combination of high heat aromatic groups can be used.

In an aspect, R^{c} and R^{d} are each independently a C₁₋₃ alkyl, or C₁₋₃ alkoxy, each R⁶ is methyl, each R³ is independently C₁₋₃ alkyl, R⁴ is methyl, or phenyl, each R⁶ is independently C₁₋₃ alkyl, or phenyl, preferably methyl, X^{b} is a C₆₋₁₂ polycyclic aryl, C₃₋₁₈ mono- or polycycloalkylene, C₃₋₁₈ mono- or polycycloalkylidene, —C(R^{f})(R^{g})— wherein R^{f} is hydrogen, C₁₋₁₂ alkyl, or C₆₋₁₂ aryl and R^{g} is C₆₋₁₀ alkyl, C₆₋₈ cycloalkyl, or C₆₋₁₂ aryl, or -(Q¹)ₓ-G-(Q²)_{y}- group, wherein Q¹ and Q² are each independently a C₁₋₃ alkylene and G is a C₃₋₁₀ cycloalkylene, x is 0 or 1, and y is 0 or 1, and j, m, and n are each independently 0 or 1.

Exemplary high heat bisphenol groups include those of formulas (7a) and (9a) to (9k).

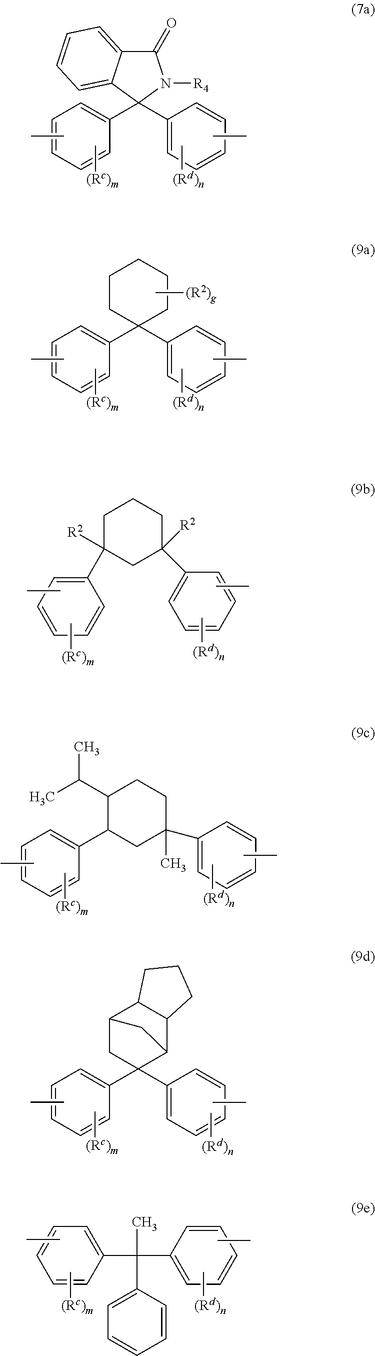

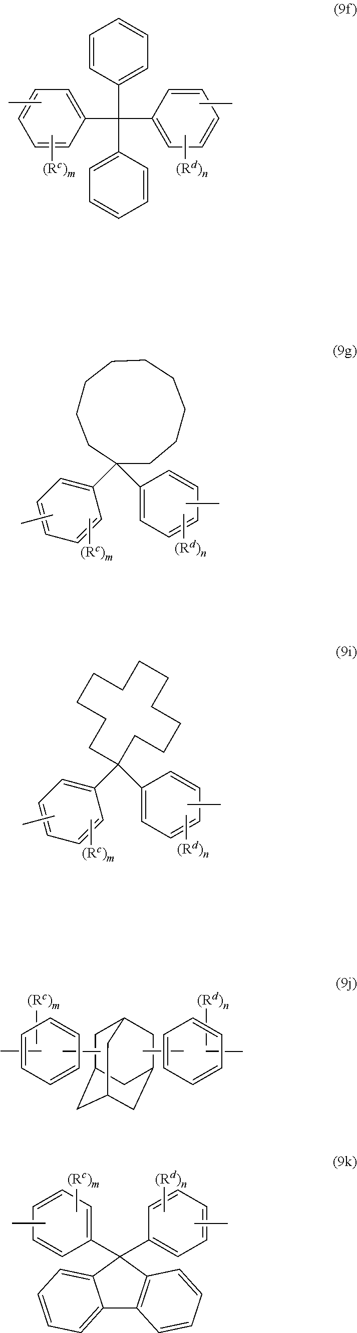

wherein R^{c} and R^{d} are the same as defined for formulas (3) to (9), each R² is independently hydrogen or C₁₋₄ alkyl, m and n are each independently 0 to 4, each R³ is independently C₁₋₄ alkyl or hydrogen, R⁴ is C₁₋₆ alkyl, or phenyl optionally substituted with 1 to 5 C₁₋₆ alkyl groups and g is 0 to 10. In a specific aspect each bond of the divalent group is located para to the linking group that is X^{a}. In an aspect, R^{c} and R^{d} are each independently a C₁₋₃ alkyl, or C₁₋₃ alkoxy, each R² is methyl, x is 0 or 1, y is 1, and m and n are each independently 0 or 1.

Preferably, the high heat aromatic group is derived the corresponding bisphenol, in particular from 3,8-dihydroxy-5a, 10b-diphenyl-coumarano-2′,3′,2,3-coumarane, 4,4′-(3,3-dimethyl-2,2-dihydro-1H-indene-1,1-diyl)diphenol, 2-phenyl-3,3′-bis(4-hydroxyphenyl) phthalimidine (PPPBP), 1,1-bis(4-hydroxyphenyl)-3,3,5-trimethyl-cyclohexane (BPI), 4,4′-(1-phenylethylidene)bisphenol, 9,9-bis(4-hydroxyphenyl)fluorene, 1,1-bis(4-hydroxyphenyl)cyclododecane, or a combination thereof.

In another preferred aspect, the high heat aromatic group is preferably of formula (7b) or (9e-1)

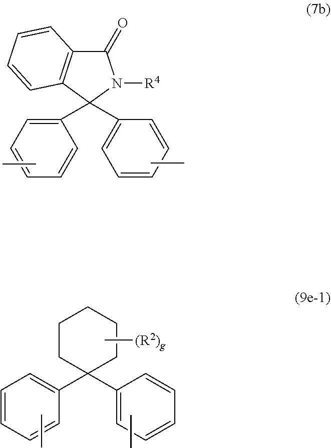

wherein R⁴ is methyl or phenyl, R⁴ is C₁₋₃ alkyl and g is 2-5. Most preferably the high heat bisphenol group is a PPPBP or BPI group.

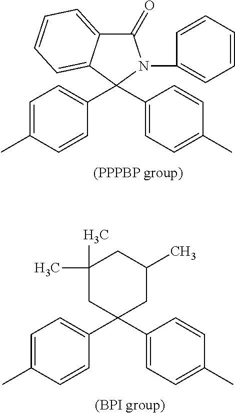

In the high heat copolycarbonates, the C₁₆ or higher divalent aromatic group (b) can be present in an amount of 10-90 mole percent (mol %), or 20-80 mol %, or 20-50 mol %, based on the total moles of the aromatic divalent groups (a) and the C₁₆ or higher divalent aromatic groups (b). The high heat copolycarbonates can have an Mw of 15,000-30,000 g/mol, as determined by GPC as described above.

The high heat copolycarbonate can be a copolymer, i.e., a copolycarbonate, comprising bisphenol A groups and high heat monomer groups, preferably PPPBP groups, BPI groups, or a combination thereof. The PPPBP or BPI groups can be present in an amount of 10-90 mol %, or 20-80 mol % of the copolycarbonate, preferably 25-40 mol %, based on the total moles of carbonate units. In an aspect, the bisphenol A-phthalimidine copolycarbonate is a diblock copolymer. These copolycarbonates can have an Mw of 15,000-30,000 g/mol.

The polycarbonate homopolymers and the copolycarbonates can be manufactured by processes such as interfacial polymerization and melt polymerization, which are known, and are described, for example, in WO 2013/175448 A1 and WO 2014/072923 A1. An end-capping agent (also referred to as a chain stopper agent or chain terminating agent) can be included during polymerization to provide end groups, for example monocyclic phenols such as phenol, p-cyanophenol, and C₁₋₂₂ alkyl-substituted phenols such as p-cumyl-phenol, resorcinol monobenzoate, and p- and tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups can be used. Branched polycarbonate blocks can be prepared by adding a branching agent during polymerization, for example trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05-2.0 wt. %. A combination of linear polycarbonates and branched polycarbonates can be used.

The composition can include a poly(carbonate-siloxane), also referred to in the art as a polycarbonate-polysiloxane copolymer. Poly(carbonate-siloxane)s have carbonate blocks of formula (1) wherein R¹ can be a low heat aromatic unit of formula (2) or a high heat aromatic unit of formulas (3-9). Preferably each R¹ is a low heat aromatic unit of formula (2), most preferably a bisphenol A unit. The polysiloxane blocks comprise repeating diorganosiloxane units as in formula (10)

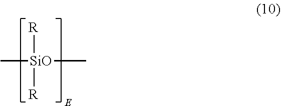

wherein each R is independently a C₁₋₁₃ monovalent organic group. For example, R can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkyleneoxy, C₇₋₁₃ alkylarylene, or C₇₋₁₃ alkylaryleneoxy. The foregoing groups can be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups can be used in the same copolymer. In an aspect, each R is independently a C₁₋₆ monovalent organic group. For example, R can be a C₁₋₆ alkyl, C₁₋₆ alkoxy, C₂₋₆ alkenyl, C₂₋₆ alkenyloxy, C₃₋₆ cycloalkyl, C₃₋₆ cycloalkoxy, C₆ aryl, or C₆ aryloxy. In an aspect, each R is independently a C₁₋₃ monovalent organic group. For example, R can be a C₁₋₃ alkyl, C₁₋₃ alkoxy, C₂₋₃ alkenyl, C₂₋₃ alkenyloxy, C₃ cycloalkyl, or C₃ cycloalkoxy. In an aspect, each R is independently a C₁ monovalent organic group. For example, R can be a methyl or a methoxy. In a preferred aspect, R is methyl.

The value of E in formula (10) can vary widely depending on the type and relative amount of each component in the thermoplastic composition, the desired properties of the composition, and like considerations. Generally, E has an average value of 2 to 1,000, or 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it can be desirable to use a relatively larger amount of the poly(carbonate-siloxane) copolymer. Conversely, where E is of a higher value, e.g., greater than 40, a relatively lower amount of the poly(carbonate-siloxane) can be used.

A combination of a first and a second (or more) poly(carbonate-siloxane)s can be used, wherein the average value of E of the first copolymer is less than the average value of E of the second copolymer.

In an aspect, the polysiloxane blocks are of formula (11)

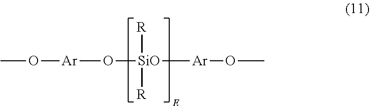

wherein E and R are as defined in formula (10) and Ar can be the same or different, and is a substituted or unsubstituted C₆₋₃₀ arylene, wherein the bonds are directly connected to an aromatic moiety. Ar groups in formula (11) can be derived from a C₆₋₃₀ dihydroxyarylene compound, for example a dihydroxyarylene compound of formula (2) or (5) above. Dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane. Combinations of at least one of the foregoing dihydroxy compounds can also be used.

In another aspect, polysiloxane blocks are of formula (12)

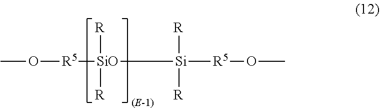

wherein E and R are as defined in formula (10), each R⁵ is independently a divalent C₁₋₃₀ organic group, and wherein the polymerized polysiloxane unit is the reaction residue of its corresponding dihydroxy compound. In a specific aspect, the polysiloxane blocks are of formula (13):

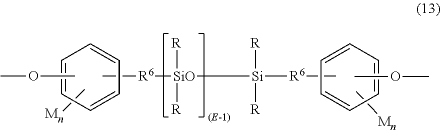

wherein R and E are as defined in formula (10). R⁶ in formula (13) is a divalent C₂₋₈ aliphatic. Each M in formula (13) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ arylalkylene, C₇₋₁₂ arylalkyleneoxy, C₇₋₁₂ alkylarylene, or C₇₋₁₂ alkylaryleneoxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, R⁶ is a divalent C₁₋₃ aliphatic group. Specific polysiloxane blocks are of the formulas

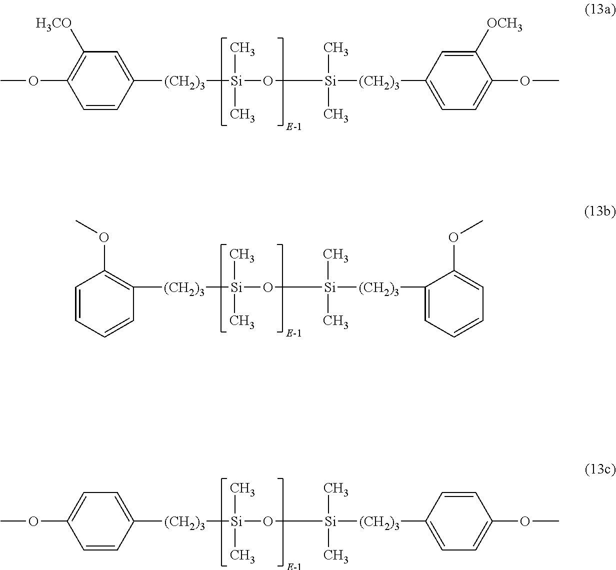

or a combination thereof, wherein E has an average value of 2-200, 2-125, 5-125, 5-100, 5-50, 20-80, or 5-20.

Blocks of formula (13) can be derived from the corresponding dihydroxy polysiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers can then be manufactured, for example, by the synthetic procedure of European Patent Application Publication No. 0 524 731 A1 of Hoover, page 5, Preparation 2.

The poly(carbonate-siloxane)s can comprise 50 to 99 wt % of carbonate units and 1-50 wt % siloxane units. Within this range, the poly(carbonate-siloxane) can comprise 70-98 wt %, or 75-97 wt % of carbonate units and 2-30 wt %, or 3-25 wt % siloxane units. In a preferred aspect, the polycarbonate is a poly(carbonate-siloxane) comprising bisphenol A carbonate units and dimethylsiloxane units, for example blocks containing 5-200 dimethylsiloxane units, such as those commercially available under the trade name EXL from SABIC.

Poly(carbonate-siloxane)s can have a weight average molecular weight of 2,000 to 100,000 Daltons, or 5,000 to 50,000 Daltons as measured by gel permeation chromatography using a crosslinked styrene-divinyl benzene column, at a sample concentration of 1 milligram per milliliter, and as calibrated with polycarbonate standards.

The poly(carbonate-siloxane)s can have a melt volume flow rate as measured at 300° C./1.2 kg, of 1-50 cubic centimeter per 10 minutes (cc/10 min), or 2-30 cc/10 min. Mixtures of poly(carbonate-siloxane)s of different flow properties can be used to achieve the overall desired flow property.

The polycarbonate composition also comprises glass fibers. The glass fibers can be present from 5-50 wt %, from 5-45 wt %, from 10-40 wt %, from 10-35 wt %, from 10-30 wt %, from 5-15 wt %, or from 8-12 wt %. The term “glass” refers generally to a material, natural or synthetic, that contains silicon dioxide (SiO₂) or silica as its main material. The glass can be E, A, C, ECR, R, S, D, or NE glasses, or the like. The glass fiber may take any shape, for example elongated fibers or “whiskers,” or glass flakes. The glass fibers can be provided in the form of monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. Co-woven structures include glass fiber-carbon fiber, carbon fiber-aromatic polyimide (aramid) fiber, and aromatic polyimide fiberglass fiber or the like. Fibrous fillers can be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids. In an aspect, the glass fiber is a non-bonding glass fiber commercially available from Owens Corning.

The polycarbonate composition includes one or more flame retardant salts, for example salts of C₂₋₁₆ alkyl sulfonates such as potassium perfluorobutane sulfonate (Rimar salt), potassium perfluoroctane sulfonate, and tetraethylammonium perfluorohexane sulfonate, salts of aromatic sulfonates such as sodium benzene sulfonate, sodium toluene sulfonate (NaTS), and the like, salts of aromatic sulfone sulfonates such as potassium diphenylsulfone sulfonate (KSS), and the like; salts formed by reacting for example an alkali metal or alkaline earth metal and an inorganic acid complex salt, preferably an alkali metal or alkaline earth metal salt of carbonic acid or a fluoro-anion complex such as Li₃AlF₆, BaSiF₆, KBF₄, K₃AlF₆, KAlF₄, K₂SiF₆, or Na₃AlF₆. Rimar salt and KSS and NaTS, alone or in combination with other flame retardants, are particularly useful. In an aspect, the flame retardant salt does not contain phosphorous. In certain aspects, the flame retardant salt is a single aromatic sulfone sulfonate. In some aspects, the flame retardant salt is a combination of two or more sulfone sulfonates. Flame retardant salts are generally present in amounts of 0.05-0.7 wt % based on the total weight of the polycarbonate composition. In some aspects, the flame retardant salt is present in amounts of 0.3-0.6 wt % based on the total weight of the polycarbonate composition. In certain aspects, the flame retardant salt is present in amounts of 0.05-0.3 wt % based on the total weight of the polycarbonate composition. In an aspect, one or more aromatic sulfonate salts is preferably present in the polycarbonate composition in a total amount of 0.05-0.7, 0.05-0.3, or 0.3-0.6 wt % based on the total weight of the polycarbonate composition. In some aspects, Rimar salt, KSS, NaTS, or a combination thereof is present in a total amount of 0.05-0.7 wt %, 0.05-0.3 wt %, or 0.3-0.6 wt % based on the total weight of the polycarbonate composition.

The polycarbonate compositions include anti-drip agents, for example a fibril forming or non-fibril forming fluoropolymer such as polytetrafluoroethylene (PTFE). Preferably, the anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. A TSAN can comprise 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Alternatively, the fluoropolymer can be pre-blended in some manner with a second polymer, such as for, example, an aromatic polycarbonate or SAN to form an agglomerated material for use as an anti-drip agent. Either method can be used to produce an encapsulated fluoropolymer. Anti-drip agents are generally used in amounts of 0.25-0.9 wt %, preferably 0.3-0.6 wt %, based on the total weight of the polycarbonate composition.

In an aspect, the polycarbonate composition comprises up to 60 wt % of the bisphenol A homopolycarbonate composition; 10-30 wt % of the poly(carbonate-siloxane); 20-50 wt % of the high heat copolycarbonate; 5-45 wt % glass fibers; and 0.05-0.7 wt % of the flame retardant salt, wherein the polycarbonate composition comprises 2-4 wt % of siloxane.

In an aspect, the polycarbonate composition comprises a bisphenol A homopolycarbonate composition; a high heat copolycarbonate comprising at least one of carbonate units derived from bisphenol A and a high heat aromatic dihydroxy compound; a flame retardant salt that is a C₂₋₁₆ alkyl sulfonate, preferably potassium perfluorobutane sulfonate, potassium perfluoroctane sulfonate, or tetraethylammonium perfluorohexane sulfonate, a salt of an aromatic sulfonates preferably sodium benzene sulfonate or sodium toluene sulfonate, a salt of an aromatic sulfone sulfonate, preferably a potassium diphenylsulfone sulfonate, a salt formed by reacting an alkali metal or alkaline earth metal and an inorganic acid complex salt, preferably an alkali metal or alkaline earth metal salt of carbonic acid or a fluoro-anion complex such as Li₃AlF₆, BaSiF₆, KBF₄, K₃AlF₆, KAlF₄, K₂SiF₆, or Na₃AlF₆; and an anti-drip agent that is a styrene-acrylonitrile-encapsulated poly(tetrafluoroethylene) copolymer.

In a preferred aspect, the composition comprises up to 60 wt % of the bisphenol A homopolycarbonate composition comprising a first bisphenol A homopolycarbonate having a weight average molecular weight from 20,000-30,000 g/mol, preferably 20,000-25,000 g/mol and a second bisphenol A homopolycarbonate having a weight average molecular weight from 25,000-35,000 g/mol, preferably 27,000-32,000 g/mol, as measured via gel permeation chromatography using bisphenol A homopolycarbonate standards; 10-20 wt % of a poly(carbonate-siloxane) comprising 15-25 wt % siloxane; 20-30 wt % of a high heat copolycarbonate comprising bisphenol A carbonate units and high heat aromatic carbonate units derived from 1,1-bis(4-hydroxyphenyl)-3,3,5-trimethyl-cyclohexane, N-phenyl phenolphthalein bisphenol, or a combination thereof; 0.05-0.3 wt % of potassium perfluorobutane sulfonate, potassium diphenylsulfone sulfonate, sodium toluene sulfonate, or a combination thereof; 8-12 wt % of glass fibers; 0.01-1.0 wt % of a phosphite heat stabilizer; and 0.3-0.6 wt % of an anti-drip agent; wherein a molded sample of the polycarbonate composition has a Vicat B120 softening temperature of at least 150° C. as measured according to ISO 306, an Izod notched impact strength of greater than or equal to 10 kJ per square meter as measured at 23° C. according to ISO 180/1 A, and a flame test rating of V1 as measured according to UL-94 at 0.8 millimeter and 1.2 millimeter thickness.

In certain aspects, the composition comprises up to 60 wt % of a bisphenol A homopolycarbonate composition comprising a bisphenol A homopolycarbonate having a weight average molecular weight from 15,000-40,000 grams/mole as measured via gel permeation chromatography using bisphenol A homopolycarbonate standards; 7-25 wt % of a poly(carbonate-siloxane); 10-70 wt %, preferably 10-50 wt % of a high heat copolycarbonate having a glass transition temperature of 170° C. or higher as determined per ASTM D3418 with a 20° C./min heating rate; 0.05-0.5 wt % of a flame retardant salt; 5-15 wt % of glass fibers; 0.25-0.9 wt %, preferably 0.3-0.6 wt %, of an anti-drip agent; and optionally, up to 10 wt % of an additive composition, wherein each amount is based on the total weight of the polycarbonate composition, which sums to 100 wt %; and wherein a molded sample of the polycarbonate composition has a Vicat B120 softening temperature of at least 150° C. as measured according to ISO 306, an Izod notched impact strength of greater than or equal to 10 kiloJoule per square meter as measured at 23° C. according to ISO 180/1 A, and a flame test rating of V1 as measured according to UL-94 at 0.8 millimeter thickness, and V0 as measured according to UL-94 at 1.2 millimeter thickness.

The polycarbonate composition can include various additives ordinarily incorporated into polymer compositions of this type, with the proviso that the additive(s) are selected so as to not significantly adversely affect the desired properties of the polycarbonate composition, in particular heat resistance and impact properties. Such additives can be mixed at a suitable time during the mixing of the components for forming the polycarbonate composition. Exemplary additives include fillers, reinforcing agents, antioxidants, heat stabilizers, light stabilizers, ultraviolet (UV) light stabilizers, plasticizers, lubricants, mold release agents, antistatic agents, colorants such as carbon black, and organic dyes, surface effect additives, radiation stabilizers, an anti-fog agent, and an antimicrobial agent. A combination of additives can be used, for example a colorant, a surface effect additive, a filler, a reinforcing agent, an antioxidant, a heat stabilizer, a light stabilizer, an ultraviolet light stabilizer, a plasticizer, a lubricant, a mold release agent, an antistatic agent, anti-fog agent, antimicrobial agent, a radiation stabilizer, or a combination thereof. The additives are used in the amounts generally known to be effective. For example, the total amount of the additives can be up to 10 wt %, preferably 0.01-5 wt %, based on the total weight of the polycarbonate composition.

In an aspect, the polycarbonate composition does not contain an impact modifier, such as an acrylonitrile-butadiene-styrene copolymer or a methyl methacrylate-butadiene-styrene copolymer.

In an aspect, the polycarbonate composition does not include titanium dioxide.

In an aspect, the additive composition comprises or consists of a heat stabilizer, an antioxidant, a mold release agent, an ultraviolet stabilizer, or a combination thereof.

Heat stabilizer additives include organophosphites (e.g. triphenyl phosphite, tris-(2,6-dimethylphenyl)phosphite, tris-(mixed mono- and di-nonylphenyl)phosphite or the like), phosphonates (e.g., dimethylbenzene phosphonate or the like), phosphates (e.g., trimethyl phosphate, or the like), or a combination thereof. The heat stabilizer can be tris(2,4-di-tert-butylphenyl) phosphite available as IRGAPHOS 168. Heat stabilizers are generally used in amounts of 0.01-5 wt %, based on the total weight of polycarbonate composition.

Antioxidant additives include organophosphites such as tris(nonyl phenyl)phosphite, tris(2,4-di-tert-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)] methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or a thereof. Antioxidants are typically used in amounts of 0.01-0.1 wt %, based on the total weight of the polycarbonate composition.

Light stabilizers, in particular ultraviolet light (UV) absorbing additives, also referred to as UV stabilizers, include hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB UV-3638 from Cytec), aryl salicylates, hydroxybenzotriazoles (e.g., 2-(2-hydroxy-5-methylphenyl)benzotriazole, 2-(2-hydroxy-5-tert-octylphenyl)benzotriazole, and 2-(2H-benzotriazol-2-yl)-4-(1,1,3,3-tetramethylbutyl)-phenol, commercially available under the trade name CYASORB 5411 from Cytec) or a combination thereof. The UV stabilizers can be present in an amount of 0.01 to 1 wt %, or, 0.1 to 0.5 wt %, or 0.15 to 0.4 wt %, each based on the total weight of polymer in the composition.

Plasticizers, lubricants, or mold release agents can also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate, and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination thereof, e.g., methyl stearate and polyethylene-polypropylene glycol copolymer in a suitable solvent; waxes such as beeswax, montan wax, paraffin wax, or the like. Such materials are generally used in amounts of 0.01 to 1.0 wt %, based on the total weight of the composition.

In an aspect, a method for the manufacture of the polycarbonate composition comprises melt-mixing the components of the polycarbonate composition. The polycarbonates and polycarbonate compositions can be formulated by various methods known in the art. For example, powdered polycarbonates, and other optional components are first blended, optionally with any fillers, in a high speed mixer or by hand mixing. The blend is then fed into the throat of a twin-screw extruder via a hopper. Alternatively, at least one of the components can be incorporated into the polycarbonate composition by feeding it directly into the extruder at the throat or downstream through a sidestuffer, or by being compounded into a masterbatch with a desired polymer and fed into the extruder. The extruder is generally operated at a temperature higher than that necessary to cause the polycarbonate composition to flow. The extrudate can be immediately quenched in a water bath and pelletized. The pellets so prepared can be one-fourth inch long or less as desired. Such pellets can be used for subsequent molding, shaping, or forming.

In an aspect, a method for forming an article comprises molding, casting, or extruding the polycarbonate composition to form the article.

Shaped, formed, or molded articles comprising the polycarbonate compositions are also provided. The polycarbonate compositions can be molded into useful shaped articles by a variety of methods, such as injection molding, extrusion, rotational molding, blow molding, and thermoforming. The article can be a molded article, a thermoformed article, an extruded film, an extruded sheet, a foamed article, a layer of a multi-layer article, a substrate for a coated article, or a substrate for a metallized article.

The article can be in the form of a component, which can be a molded housing.

The component can be an electrical circuit housing. The component can be an electrical device component, a medical device component, or a housing component for an electrical device, a vehicle light, a cell phone, a computer, a docking station, a personal data assistant (PDA), a MP3 player, a global positioning satellite (GPS) module, a circuit breaker case, or the like. Specific examples of components include computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like. The articles, polycarbonate compositions, and methods are further illustrated by the following non-limiting examples.

### Examples

The following components are used in the examples. Unless specifically indicated otherwise, the amount of each component is in wt %, based on the total weight of the polycarbonate composition.

The materials shown in Table 1 were used.

TABLE 1

| Component | Description | Source |
|---|---|---|
| PC-1 | Linear bisphenol A polycarbonate produced by | SABIC |
| | interfacial polymerization, Mw = 21,000-23,000 | |
| | g/mol, having a melt flow rate of about 6 | |
| | grams per 10 minutes at 300° C. and 1.2 | |
| | kilogram load | |
| PC-2 | Linear bisphenol A polycarbonate produced by | SABIC |
| | interfacial polymerization, Mw = 28,000-30,900 | |
| | g/mol, having a melt flow rate of about 30 | |
| | grams per 10 minutes at 300° C. and 1.2 | |
| | kilogram load | |
| PC-3 | PPPBP (N-Phenylphenolphthaleinylbisphenol, | |
| | 2,2-bis(4-hydro) - bisphenol A copolycarbonate, | SABIC |
| | 32 mol % PPPBP, Mw 23,000 g/mol interfacial | |
| | polymerization, PCP end-capped, PDI = 2-3, | |
| | available as XHT | |
| PC-Si | PDMS (polydimethylsiloxane) - bisphenol A | SABIC |
| | polycarbonate copolymer, produced via | |
| | interfacial polymerization, 20 wt % siloxane, | |
| | average PDMS block length of 45 units (D45), | |
| | Mw = 29,000-31,000 g/mol, as determined by | |
| | GPC using bisphenol A homopolycarbonate | |
| | standards, para-cumylphenol (PCP) | |
| | end-capped, PDI = 2-3 | |
| KSS | Potassium diphenylsulfone sulfonate | Arichem |
| | | LLC |
| PETS | Pentaerythritol tetrastearate | Faci |
| TSAN | Styrene-acrylonitrile (SAN)-encapsulated | SABIC |
| | PTFE | |
| NaTS | Sodium p-toluenesulfonate | Arichem |
| | | LLC |
| Phosphite | Tris(2,4-di-tert-butylphenyl)phosphite | Ciba |
| UVA | 2-(2-Hydroxy-5-t-octylphenyl) benzotriazole, | UVA |
| | available as UVA 5411 | Hunan |
| NBGF | Non-binding fiberglass | Owens |
| | | Corning |

The samples were prepared as described below and the following test methods were used.

Extrusion for all blends was performed on a 25 mm twin-screw extruder, using a nominal melt temperature of 280-320° C. and 300 revolutions per minute (rpm). All powder additives were blended together with the PC powders using a paint shaker and fed through one feeder. The glass fiber was fed separately through a down-stream feeder.

Granulate was dried for 3 h at 120° C. Test specimens were produced from the dried pellets and were injection-molded at nominal temperatures of 300-320° C. to form specimens for most of the tests below.

Heat deformation under pressure (BPT) was measured using ball pressure tests performed on the ends of 4 mm tensile bars, in accordance with the IEC 60695 standard at various temperatures. The results are in millimeter (mm) at a specific temperature or as an approximate pass temperature. The pass temperature was determined by extrapolation of the data at various temperatures to the temperature at which the width of the dent was 2 mm.

Heat distortion temperatures (HDT) were determined in accordance with the ISO-75 standard with a 5.5 J hammer, using the flat side of 4 mm ISO bars and a load of 1.8 MPa (A/f).

Impact resistance was determined by ISO-180 with a 5.5 J hammer. Ductility was expressed as a percentage of the bars showing failure. Five bars were tested for each composition.

Melt volume rates (MVR) were measured in accordance with the ISO-1133 standard at 250° C. under a load of 5 kg with residence time of 5 minutes. The granules were dried for 3 hours at 120° C.

Vicat softening temperatures were measured on 4 mm ISO bars in accordance with the ISO-306 standard at a load of 10 N and a speed of 50°/hr (A50) or a load of 50 N and a speed of 120° C./hr (B120).

Flammability was determined by using the UL-94 standard. Vx vertical flammability tests were performed at 0.8 mm. Total flame-out (FOT) for all 5 bars was: FOT=t1+t2. V-ratings obtained for every set of 5 bars, according to the criteria in Table 2.

TABLE 2

| | t₁ and/or t₂ | 5-bar FOT | burning drips |
|---|---|---|---|
| V0 | <10 | <50 | No |
| V1 | <30 | <250 | No |
| V2 | <30 | <250 | yes |
| N.R. (no rating) | >30 | >250 | |

The formulations and properties of Comparative Examples 1-4 (CEx 1-4) and Examples 1-4 (Ex 1-4) are shown in Table 3.

TABLE 3

| Component (%) | Units | CEx1 | CEx2 | Ex1 | CEx3 | CEx4 | Ex2 | Ex3 | Ex4 |
|---|---|---|---|---|---|---|---|---|---|
| PC-1 | % | 51.15 | 28 | 53.85 | 28.4 | 28.3 | 28.2 | 28 | 27.6 |
| KSS | % | 0.5 | 0.5 | 0.5 | 0.16 | 0.16 | 0.16 | 0.16 | 0.16 |
| TSAN | % | | 0.2 | 0.5 | 0.1 | 0.2 | 0.3 | 0.5 | 0.9 |
| NaTS | % | 0.15 | 0.15 | 0.15 | 0.06 | 0.06 | 0.06 | 0.06 | 0.06 |
| AO | % | 0.05 | 0.05 | 0.05 | 0.05 | 0.05 | 0.05 | 0.05 | 0.05 |
| UVA | % | 0.15 | 0.15 | 0.15 | 0.15 | 0.15 | 0.15 | 0.15 | 0.15 |
| PC-2 | % | | | | 23.08 | 23.08 | 23.08 | 23.08 | 23.08 |
| NBFG | % | 9 | 9 | 9 | 9 | 9 | 9 | 9 | 9 |
| PC-Si | % | 12 | 12 | 12 | 12 | 12 | 12 | 12 | 12 |
| PC-3 | % | 27 | 27 | 27 | 27 | 27.0 | 27 | 27 | 27 |
| Total | % | 100 | 100 | 100 | 100 | 100 | 100 | 100 | 100 |

Properties

| MVR at 300° C., 1.2 kg, 300 sec | | cm³/10 min | 9.8 | 7.1 | 6.2 | 6.9 | 6.0 | 5.6 | 4.7 | 3.4 |
|---|---|---|---|---|---|---|---|---|---|---|
| MVR at 330° C., 1.2 kg, 300 sec | | cm³/10 min | 26.5 | 21.3 | 18.1 | 22.2 | 19.6 | 18 | 16.2 | 13.5 |
| BPT (150° C.) | | | Pass | Pass | Pass | Pass | Pass | Pass | Pass | Pass |
| VICAT (B/120) | | ° C. | 158 | 157 | 157 | 159 | 158 | 157 | 157 | 155 |
| IZOD INI (3 mm, 23° C.) | | kJ/m² | 13 | 14 | 13 | 16 | 15 | 15 | 15 | 15 |
| UL-94 at | FOT 23° C., 48 hr | | | | | | | | | |
| 0.8 mm | S t1 | s | 29 | 30 | 50 | 68 | 44 | 41 | 27 | 24 |
| | S t2 | s | 20 | 75 | 41 | 34 | 49 | 36 | 45 | 61 |
| | S (t1 + t2) | s | 49 | 105 | 91 | 102 | 93 | 77 | 72 | 85 |
| | V-rating | | V2 | V2 | V1 | V2 | V2 | V1 | V1 | V1 |
| UL-94 at | FOT 23° C., 48 hr | | | | | | | | | |
| 1.2 mm | S t1 | s | 46 | 15 | 20 | 22 | 12 | 19 | 15 | 7 |
| | S t2 | s | 23 | 42 | 39 | 31 | 30 | 36 | 23 | 18 |
| | S (t1 + t2) | s | 69 | 57 | 59 | 53 | 42 | 55 | 38 | 25 |
| | V-rating | | V2 | V1 | V1 | V1 | V1 | V0 | V0 | V0 |

As can be seen from the data in Table 3, the addition of the TSAN and a decrease in the amount of the flame retardant salt lead to an improved UL-94 rating at both 0.8 mm and 1.2 mm. It also improved the robustness of the non-dripping compositions, as evidenced by the lower flame out times. At high loadings of TSAN, beyond 0.09% (data not shown), there was a large decrease in MVR, which could limit the practical use of compositions having greater than 0.09% TSAN in thin wall applications. Therefore, to avoid decreases in MVR, loadings of TSAN were maintained below 0.9%.

The formulations and properties of preferred aspects are shown in Table 4. Comparison of Example 3 (Ex 3, Runs 1 and 2) and Example 5 (Ex 5) show the effect of modifying the viscosity of the composition.

TABLE 4

| Component (%) | Units | Ex3-Run 1 | Ex5 | Ex3-Run 2 | Ex6 | Ex7 | Ex8 |
|---|---|---|---|---|---|---|---|
| PC-1 | % | 28.08 | 51.08 | 28 | 28 | 28 | 28 |
| KSS | % | 0.16 | 0.16 | 0.16 | 0.16 | 0.16 | 0.16 |
| TSAN | % | 0.5 | 0.5 | 0.5 | 0.5 | 0.5 | 0.5 |
| NaTS | % | 0.06 | 0.06 | 0.06 | 0.06 | 0.06 | 0.06 |
| AO | % | 0.05 | 0.05 | 0.05 | 0.05 | 0.05 | 0.05 |
| UVA | % | 0.15 | 0.15 | 0.15 | 0.15 | 0.15 | 0.15 |
| PC-2 | % | 23 | | 23.08 | 20.05 | 22.07 | 22.06 |
| NBFG | % | 9 | 9 | 9 | 9 | 9 | 9 |
| PC-Si | % | 12 | 12 | 12 | 12 | 12 | 12 |
| PC-3 | % | 27 | 27 | 27 | 27 | 27.0 | 27 |
| Pigment Blue 29 | % | | | | | | |
| Titanium Dioxide | % | | | | 3 | 0.02 | 0.02 |
| Pigment Black 7 | % | | | | | | 1 |
| Solvent Yellow 163 | % | | | | | 0.33 | |
| Solvent Blue 104 | % | | | | | 0.33 | |
| Solvent Red 207 | % | | | | | 0.33 | |
| Pigment Yellow 138 | % | | | | 0.03 | | |
| Total | % | 100 | 100 | 100 | 100 | 100 | 100 |

Properties

| MVR at 300° C., 1.2 kg, 300 sec | | cm³/10 min | 3.9 | 5.5 | 4.9 | 4.0 | 5.2 | 4.2 |
|---|---|---|---|---|---|---|---|---|
| MVR at 330° C., 1.2 kg, 300 sec | | cm³/10 min | 18.5 | 25.0 | 14.7 | 14.4 | 16.7 | 13.0 |
| IZOD INI (3 mm, 23° C.) | | kJ/m² | 13 | 10 | 14 | 14 | 11 | 13 |
| BPT (150° C.) | | | Pass | Pass | Pass | Pass | Pass | Pass |
| UL-94 at | FOT 23° C., 48 hr | | | | | | | |
| 0.8 mm | S t1 | s | 29 | 40 | 24 | 35 | 33 | 12 |
| | S t2 | s | 27 | 13 | 22 | 62 | 15 | 26 |
| | S (t1 + t2) | s | 56 | 53 | 46 | 97 | 48 | 38 |
| | V-rating | | V1 | V1 | V0 | V1 | V1 | V0 |
| UL-94 at | FOT 70° C., 168 hr | | | | | | | |
| 0.8 mm | S t1 | s | 29 | 25 | 18 | 32 | 42 | 10 |
| | S t2 | s | 59 | 48 | 45 | 34 | 26 | 29 |
| | S (t1 + t2) | s | 88 | 73 | 63 | 66 | 68 | 39 |
| | V-rating | | V1 | V1 | V1 | V0 | V1 | V0 |
| UL-94 at | FOT 23° C., 48 hr | | | | | | | |
| 1.2 mm | S t1 | s | 12 | 14 | 14 | 8 | 8 | 6 |
| | S t2 | s | 22 | 25 | 23 | 23 | 22 | 9 |
| | S (t1 + t2) | s | 34 | 39 | 37 | 31 | 30 | 15 |
| | V-rating | | V0 | V0 | V0 | V0 | V0 | V0 |
| UL-94 at | FOT 70° C., 168 hr | | | | | | | |
| 1.2 mm | S t1 | s | 13 | 12 | 10 | 7 | 11 | 8 |
| | S t2 | s | 24 | 26 | 23 | 21 | 20 | 13 |
| | S (t1 + t2) | s | 37 | 38 | 33 | 28 | 31 | 21 |
| | V-rating | | V0 | V0 | V0 | V0 | V0 | V0 |

As can be seen from the data in Table 4, the preferred aspects yielded robust color and UL-94 performance (V1 at 0.8 mm and V0 at 1.2 mm) across the agency colors, at different conditioning parameters and viscosities as seen by modifying the polycarbonate molecular weight.

TABLE 5

| Component (%) | | Units | Ex9 | Ex10 | Ex11 | Ex12 | Ex13 |
|---|---|---|---|---|---|---|---|
| PC-1 | | % | 21 | 38.08 | 18 | 28 | 23.08 |
| KSS | | % | 0.16 | 0.16 | 0.16 | 0.16 | 0.16 |
| TSAN | | % | 0.5 | 0.5 | 0.5 | 0.5 | 0.5 |
| NaTS | | % | 0.15 | 0.15 | 0.15 | 0.06 | 0.06 |
| AO | | % | 0.05 | 0.05 | 0.05 | 0.05 | 0.05 |
| UVA | | % | 0.15 | 0.15 | 0.15 | 0.15 | 0.15 |
| PC-2 | | % | 17.08 | | 15.08 | 5.08 | |
| NBFG | | % | 15 | 15 | 20 | 20 | 30 |
| PC-Si | | % | 22 | 22 | 22 | 22 | 22 |
| PC-3 | | % | 24 | 24 | 24 | 24 | 24 |
| Total | | % | 100 | 100 | 100 | 100 | 100 |
| MVR at 300° C., 1.2 kg, 300 sec | | cm³/10 min | 4.0 | 4.8 | 4.0 | 4.4 | 5.8 |
| MVR at 330° C., 1.2 kg, 300 sec | | cm³/10 min | 8.7 | 14.1 | 14.6 | 14.8 | 18.3 |
| BPT (150° C.) | | | Pass | Pass | Pass | Pass | Pass |
| VICAT (B/120) | | ° C. | 155 | 155 | 156 | 156 | 156 |
| IZOD INI (3 mm, 23° C.) | | kJ/m² | 16 | 15 | 16 | 15 | 12 |
| UL-94 at | FOT 23° C., 48 hr | | | | | | |
| 0.8 mm | S t1 | s | 65 | 29 | 63 | 39 | 74 |
| | S t2 | s | 40 | 28 | 38 | 49 | 17 |
| | S (t1 + t2) | s | 106 | 57 | 101 | 88 | 90 |
| | V-rating | | V-1 | V-0 | V-1 | V1 | V1 |
| UL-94 at | FOT 23° C., 48 hr | | | | | | |
| 1.2 mm | S t1 | s | 10 | 11 | 25 | 25 | 64 |
| | S t2 | s | 30 | 37 | 57 | 53 | 71 |
| | S (t1 + t2) | s | 40 | 48 | 81 | 78 | 135 |
| | V-rating | | V1 | V1 | V1 | V1 | V1 |

As can be seen from the data in Table 5, the preferred aspects yielded the disclosed UL-94 performance (V1 at 0.8 mm and at 1.2 mm) at higher glass content.

This disclosure further encompasses the following aspects.

Aspect 1: An article comprising a polycarbonate composition, the composition comprising up to 60 wt % of a bisphenol A homopolycarbonate composition comprising a bisphenol A homopolycarbonate having a weight average molecular weight from 15,000-40,000 grams/mole as measured via gel permeation chromatography using bisphenol A homopolycarbonate standards; 7-30 wt % of a poly(carbonate-siloxane); 10-70 wt %, preferably 10-50 wt % of a high heat copolycarbonate having a glass transition temperature of 170° C. or higher as determined per ASTM D3418 with a 20° C./min heating rate; 0.05-0.7 wt % of a flame retardant salt; 5-45 wt % of glass fibers; 0.25-0.9 wt %, preferably 0.3-0.6 wt %, of an anti-drip agent; and optionally, up to 10 wt % of an additive composition, wherein each amount is based on the total weight of the polycarbonate composition, which sums to 100 wt %; and wherein a molded sample of the polycarbonate composition has a Vicat B120 softening temperature of at least 150° C. as measured according to ISO 306, an Izod notched impact strength of greater than or equal to 10 kiloJoule per square meter as measured at 23° C. according to ISO 180/1 A, and a flame test rating of V1 as measured according to UL-94 at 0.8 millimeter and 1.2 millimeter thickness, more preferably V0 at 1.2 millimeter.

Aspect 2: The article of Aspect 1, wherein the bisphenol A homopolycarbonate composition comprises a first bisphenol A homopolycarbonate having a weight average molecular weight from 20,000-30,000 grams/mole, preferably 20,000-25,000 grams/mole, and a second bisphenol A homopolycarbonate having a weight average molecular weight from 25,000-35,000 grams/mole, preferably 27,000-32,000 grams/mole as measured via gel permeation chromatography using bisphenol A homopolycarbonate standards.

Aspect 3: The article of Aspect 1, wherein the polycarbonate composition comprises up to 60 wt % of the bisphenol A homopolycarbonate composition; 10-30 wt % of the poly(carbonate-siloxane); 20-50 wt % of the high heat copolycarbonate; 5-45 wt % of glass fibers; and 0.05-0.7 wt % of the flame retardant salt, wherein each amount is based on the total weight of the polycarbonate composition, which sums to 100 wt % and wherein the polycarbonate composition comprises 2-4 wt % of siloxane.

Aspect 4: The article of Aspect 1, wherein the high heat aromatic carbonate comprises low heat aromatic carbonate units, preferably bisphenol A carbonate units; and high heat aromatic carbonate units, preferably high heat aromatic carbonate units derived from 1,1-bis(4-hydroxyphenyl)-3,3,5-trimethyl-cyclohexane, N-phenyl phenolphthalein bisphenol, 4,4′-(1-phenylethylidene)bisphenol, 4,4′-(3,3-dimethyl-2,2-dihydro-1H-indene-1,1-diyl)diphenol, 1,1-bis(4-hydroxyphenyl)cyclododecane, 3,8-dihydroxy-5a, 10b-diphenyl-coumarano-2′,3′,2,3-coumarane, or a combination thereof.

Aspect 5: The article of Aspect 1, wherein the high heat copolycarbonate comprises bisphenol A carbonate units and high heat aromatic carbonate units derived from 1,1-bis(4-hydroxyphenyl)-3,3,5-trimethyl-cyclohexane, N-phenyl phenolphthalein bisphenol, or a combination thereof.

Aspect 6: The article of Aspect 1, wherein the flame retardant salt comprises a C₂₋₁₆ alkyl sulfonate, preferably potassium perfluorobutane sulfonate, potassium perfluoroctane sulfonate, or tetraethylammonium perfluorohexane sulfonate, a salt of an aromatic sulfonate, preferably sodium benzene sulfonate or sodium toluene sulfonate, a salt of an aromatic sulfone sulfonate, preferably a potassium diphenylsulfone sulfonate, a salt formed by reacting for example an alkali metal or alkaline earth metal and an inorganic acid complex salt, preferably an alkali metal or alkaline earth metal salt of carbonic acid or a fluoro-anion complex such as Li₃AlF₆, BaSiF₆, KBF₄, K₃AlF₆, KAlF₄, K₂SiF₆, or Na₃AlF₆, or a combination thereof.

Aspect 7: The article of Aspect 6, wherein the flame retardant salt is potassium perfluorobutane sulfonate, potassium diphenylsulfone sulfonate, sodium toluene sulfonate, or a combination thereof.

Aspect 8: The article of Aspect 1, wherein the high heat copolycarbonate comprises bisphenol A carbonate units and high heat aromatic carbonate units derived from 1,1-bis(4-hydroxyphenyl)-3,3,5-trimethyl-cyclohexane, N-phenyl phenolphthalein bisphenol, or a combination thereof; the flame retardant salt comprises a salt of an aromatic sulfone sulfonate and a salt of an aromatic sulfonate; and the anti-drip agent is styrene-acrylonitrile-encapsulated poly(tetrafluoroethylene) copolymer.

Aspect 9: The article of Aspect 1, comprising up to 60 wt % of a bisphenol A homopolycarbonate composition comprising a first bisphenol A homopolycarbonate having a weight average molecular weight from 20,000-30,000 grams/mole, preferably 20,000-25,000 grams/mole and a second bisphenol A homopolycarbonate having a weight average molecular weight from 25,000-35,000 grams/mole, preferably 27,000-32,000 grams/mole, as measured via gel permeation chromatography using bisphenol A homopolycarbonate standards; 10-20 wt % of a poly(carbonate-siloxane) containing 15-25 wt % siloxane; 20-30 wt % of a high heat copolycarbonate comprising bisphenol A carbonate units and high heat aromatic carbonate units derived from 1,1-bis(4-hydroxyphenyl)-3,3,5-trimethyl-cyclohexane, N-phenyl phenolphthalein bisphenol, or a combination thereof; 0.05-0.3 wt % of potassium perfluorobutane sulfonate, potassium diphenylsulfone sulfonate, sodium toluene sulfonate, or a combination thereof; 8-12 wt % of glass fibers; 0.01-1.0 wt % of a phosphite heat stabilizer; and 0.3-0.6 wt % of an anti-drip agent; wherein each amount is based on the total weight of the polycarbonate composition, which sums to 100 wt %; and wherein a molded sample of the polycarbonate composition has a Vicat B120 softening temperature of at least 150° C. as measured according to ISO 306, an Izod notched impact strength of greater than or equal to 10 kilojoule per square meter as measured at 23° C. according to ISO 180/1 A, and a flame test rating of V1 as measured according to UL-94 at 0.8 millimeter and 1.2 millimeter thickness.

Aspect 10: An article according to Aspect 1 wherein the composition comprises up to 60 wt % of a bisphenol A homopolycarbonate composition comprising a bisphenol A homopolycarbonate having a weight average molecular weight from 15,000-40,000 grams/mole as measured via gel permeation chromatography using bisphenol A homopolycarbonate standards; 7-25 wt % of a poly(carbonate-siloxane); 10-70 wt %, preferably 10-50 wt % of a high heat copolycarbonate having a glass transition temperature of 170° C. or higher as determined per ASTM D3418 with a 20° C./min heating rate; 0.05-0.5 wt % of a flame retardant salt; 5-15 wt % of glass fibers; 0.25-0.9 wt %, preferably 0.3-0.6 wt %, of an anti-drip agent; and optionally, up to 10 wt % of an additive composition, wherein each amount is based on the total weight of the polycarbonate composition, which sums to 100 wt %; and wherein a molded sample of the polycarbonate composition has a Vicat B120 softening temperature of at least 150° C. as measured according to ISO 306, an Izod notched impact strength of greater than or equal to 10 kiloJoule per square meter as measured at 23° C. according to ISO 180/1 A, and a flame test rating of V1 as measured according to UL-94 at 0.8 millimeter thickness, and V0 as measured according to UL-94 at 1.2 millimeter thickness.

Aspect 11: The article of Aspect 1, wherein the article is a molded article, a thermoformed article, an extruded film, an extruded sheet, a foamed article, a layer of a multi-layer article, a substrate for a coated article, or a substrate for a metallized article.

Aspect 12: The article of aspect 10, wherein the article is a molded housing.

Aspect 13: The article of aspect 12, wherein the article is an electrical circuit housing.

Aspect 14: A method for forming the article of Aspect 1, comprising molding, casting, or extruding the article.

The singular forms “a,” “an,” and “the” include plural referents unless the context clearly dictates otherwise. “Or” means “and/or” unless clearly indicated otherwise by context. A “combination thereof” is open and includes any combination comprising at least one of the listed components or properties optionally together with a like or equivalent component or property not listed The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group.

The suffix “(s)” is intended to include both the singular and the plural of the term that it modifies, thereby including at least one of that term (e.g., the filler(s) includes at least one filler). “Optional” or “optionally” means that the subsequently described event or circumstance may or may not occur, and that the description includes instances where the event occurs and instances where it does not. Unless defined otherwise, technical and scientific terms used herein have the same meaning as is commonly understood by one of skill in the art to which this disclosure belongs. A “combination” is inclusive of blends, mixtures, alloys, reaction products, and the like. The terms “first,” “second,” and the like, “primary,” “secondary,” and the like, as used herein do not denote any order, quantity, or importance, but rather are used to distinguish one element from another.

As used herein, the term “hydrocarbyl” and “hydrocarbon” mean broadly a substituent comprising carbon and hydrogen, optionally with 1-3 heteroatoms, for example, oxygen, nitrogen, halogen, silicon, sulfur, or a combination thereof; “alkyl” means a straight or branched chain, saturated monovalent hydrocarbon group; “alkylene” means a straight or branched chain, saturated, divalent hydrocarbon group; “alkylidene” means a straight or branched chain, saturated divalent hydrocarbon group, with both valences on a single common carbon atom; “alkenyl” means a straight or branched chain monovalent hydrocarbon group having at least two carbons joined by a carbon-carbon double bond; “cycloalkyl” means a non-aromatic monovalent monocyclic or multicyclic hydrocarbon group having at least three carbon atoms, “cycloalkenyl” means a non-aromatic cyclic divalent hydrocarbon group having at least three carbon atoms, with at least one degree of unsaturation; “aryl” means an aromatic monovalent group containing only carbon in the aromatic ring or rings; “arylene” means an aromatic divalent group containing only carbon in the aromatic ring or rings; “alkylarylene” means an arylene group that has been substituted with an alkyl group, with 4-methylphenyl being an exemplary alkylarylene group; “arylalkylene” means an alkylene group substituted with an aryl group, with benzyl being an exemplary arylalkylene group; “acyl” means an alkyl group with the indicated number of carbon atoms attached through a carbonyl carbon bridge (—C(═O)—); “alkoxy” means an alkyl group with the indicated number of carbon atoms attached through an oxygen bridge (—O—); and “aryloxy” means an aryl group with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents or variables are permissible provided that the substitutions do not significantly adversely affect synthesis or use of the compound. Exemplary groups that can be present on a “substituted” position include, but are not limited to, cyano; hydroxyl; nitro; azido; alkanoyl (such as a C₂₋₆ alkanoyl group such as acyl); carboxamido; C₁₋₆ or C₁₋₃ alkyl, cycloalkyl, alkenyl, and alkynyl (including groups having at least one unsaturated linkages and from 2-8, or 2-6 carbon atoms); C₁₋₆ or C₁₋₃ alkoxys; C₆₋₁₀ aryloxy such as phenoxy; C₁₋₆ alkylthio; C₁₋₆ or C₁₋₃ alkylsulfinyl; C₁₋₆ or C₁₋₃ alkylsulfonyl; aminodi(C₁₋₆ or C₁₋₃)alkyl; C₆₋₁₂ aryl having at least one aromatic rings (e.g., phenyl, biphenyl, naphthyl, or the like, each ring either substituted or unsubstituted aromatic); C₇₋₁₉ arylalkylene having 1-3 separate or fused rings and from 6-18 ring carbon atoms; or arylalkyleneoxy having 1-3 separate or fused rings and from 6-18 ring carbon atoms, with benzyloxy being an exemplary arylalkyleneoxy.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical aspects have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

We claim:

1. An article comprising a polycarbonate composition, the composition comprising
up to 60 wt % of a bisphenol A homopolycarbonate composition comprising a bisphenol A homopolycarbonate having a weight average molecular weight from 15,000-40,000 grams/mole as measured via gel permeation chromatography using bisphenol A homopolycarbonate standards;
7-30 wt % of a poly(carbonate-siloxane);
10-70 wt %, preferably 10-50 wt % of a high heat copolycarbonate having a glass transition temperature of 170° C. or higher as determined per ASTM D3418 with a 20° C./min heating rate;
0.05-0.7 wt % of a flame retardant salt;
5-45 wt % of glass fibers;
0.25-0.9 wt %, preferably 0.3-0.6 wt %, of an anti-drip agent; and
optionally, up to 10 wt % of an additive composition,
wherein each amount is based on the total weight of the polycarbonate composition, which sums to 100 wt %; and wherein a molded sample of the polycarbonate composition has
a Vicat B120 softening temperature of at least 150° C. as measured according to ISO 306,
an Izod notched impact strength of greater than or equal to 10 kiloJoule per square meter as measured at 23° C. according to ISO 180/1 A, and
a flame test rating of
V1 as measured according to UL-94 at 0.8 millimeter and 1.2 millimeter thickness, more preferably V0 at 1.2 millimeter.

2. The article of claim 1, wherein the bisphenol A homopolycarbonate composition comprises a first bisphenol A homopolycarbonate having a weight average molecular weight from 20,000-30,000 grams/mole, preferably 20,000-25,000 grams/mole, and a second bisphenol A homopolycarbonate having a weight average molecular weight from 25,000-35,000 grams/mole, preferably 27,000-32,000 grams/mole as measured via gel permeation chromatography using bisphenol A homopolycarbonate standards.

3. The article of claim 1, wherein the polycarbonate composition comprises
up to 60 wt % of the bisphenol A homopolycarbonate composition;
10-30 wt % of the poly(carbonate-siloxane);
20-50 wt % of the high heat copolycarbonate;
5-45 wt % of glass fibers; and
0.05-0.7 wt % of the flame retardant salt,
wherein each amount is based on the total weight of the polycarbonate composition, which sums to 100 wt % and wherein the polycarbonate composition comprises 2-4 wt % of siloxane.

4. The article of claim 1, wherein the high heat copolycarbonate comprises
low heat aromatic carbonate units, preferably bisphenol A carbonate units; and
high heat aromatic carbonate units, preferably high heat aromatic carbonate units derived from 1,1-bis(4-hydroxyphenyl)-3,3,5-trimethyl-cyclohexane, N-phenyl phenolphthalein bisphenol, 4,4′-(1-phenylethylidene)bisphenol, 4,4′-(3,3-dimethyl-2,2-dihydro-H-indene-1,1-diyl)diphenol, 1,1-bis(4-hydroxyphenyl)cyclododecane, 3,8-dihydroxy-5a,10b-diphenyl-coumarano-2′,3′,2,3-coumarane, or a combination thereof.

5. The article of claim 1, wherein the high heat copolycarbonate comprises bisphenol A carbonate units and high heat aromatic carbonate units derived from 1,1-bis(4-hydroxyphenyl)-3,3,5-trimethyl-cyclohexane, N-phenyl phenolphthalein bisphenol, or a combination thereof.

6. The article of claim 1, wherein the flame retardant salt comprises
a C₂₋₁₆ alkyl sulfonate, preferably potassium perfluorobutane sulfonate, potassium perfluoroctane sulfonate, or tetraethylammonium perfluorohexane sulfonate,
a salt of an aromatic sulfonate, preferably sodium benzene sulfonate or sodium toluene sulfonate,
a salt of an aromatic sulfone sulfonate, preferably a potassium diphenylsulfone sulfonate,
a salt formed by reacting for example an alkali metal or alkaline earth metal and an inorganic acid complex salt, preferably an alkali metal or alkaline earth metal salt of carbonic acid or a fluoro-anion complex such as Li₃AlF₆, BaSiF₆, KBF₄, K₃AlF₆, KAlF₄, K₂SiF₆, or Na₃AlF₆, or a combination thereof.

7. The article of claim 6, wherein the flame retardant salt is potassium perfluorobutane sulfonate, potassium diphenylsulfone sulfonate, sodium toluene sulfonate, or a combination thereof.

8. The article of claim 1, wherein
the high heat copolycarbonate comprises bisphenol A carbonate units and high heat aromatic carbonate units derived from 1,1-bis(4-hydroxyphenyl)-3,3,5-trimethyl-cyclohexane, N-phenyl phenolphthalein bisphenol, or a combination thereof;
the flame retardant salt comprises a salt of an aromatic sulfone sulfonate and a salt of an aromatic sulfonate; and
the anti-drip agent is styrene-acrylonitrile-encapsulated poly(tetrafluoroethylene) copolymer.

9. The article of claim 1, comprising
up to 60 wt % of a bisphenol A homopolycarbonate composition comprising a first bisphenol A homopolycarbonate having a weight average molecular weight from 20,000-30,000 grams/mole, preferably 20,000-25,000 grams/mole and a second bisphenol A homopolycarbonate having a weight average molecular weight from 25,000-35,000 grams/mole, preferably 27,000-32,000 grams/mole, as measured via gel permeation chromatography using bisphenol A homopolycarbonate standards;
10-20 wt % of a poly(carbonate-siloxane) containing 15-25 wt % siloxane;
20-30 wt % of a high heat copolycarbonate comprising bisphenol A carbonate units and high heat aromatic carbonate units derived from 1,1-bis(4-hydroxyphenyl)-3,3,5-trimethyl-cyclohexane, N-phenyl phenolphthalein bisphenol, or a combination thereof;
0.05-0.3 wt % of potassium perfluorobutane sulfonate, potassium diphenylsulfone sulfonate, sodium toluene sulfonate, or a combination thereof;
8-12 wt % of glass fibers;
0.01-1.0 wt % of a phosphite heat stabilizer; and
0.3-0.6 wt % of an anti-drip agent;
wherein each amount is based on the total weight of the polycarbonate composition, which sums to 100 wt %; and wherein a molded sample of the polycarbonate composition has
a Vicat B120 softening temperature of at least 150° C. as measured according to ISO 306,
an Izod notched impact strength of greater than or equal to 10 kJ per square meter as measured at 23° C. according to ISO 180/1 A, and
a flame test rating of V1 as measured according to UL-94 at 0.8 millimeter and 1.2 millimeter thickness.

10. An article according to claim 1 wherein the composition comprises
up to 60 wt % of a bisphenol A homopolycarbonate composition comprising a bisphenol A homopolycarbonate having a weight average molecular weight from 15,000-40,000 grams/mole as measured via gel permeation chromatography using bisphenol A homopolycarbonate standards;
7-25 wt % of a poly(carbonate-siloxane);
10-70 wt %, preferably 10-50 wt % of a high heat copolycarbonate having a glass transition temperature of 170° C. or higher as determined per ASTM D3418 with a 20° C./min heating rate;
0.05-0.5 wt % of a flame retardant salt;
5-15 wt % of glass fibers;
0.25-0.9 wt %, preferably 0.3-0.6 wt %, of an anti-drip agent; and
optionally, up to 10 wt % of an additive composition,
wherein each amount is based on the total weight of the polycarbonate composition, which sums to 100 wt %; and wherein a molded sample of the polycarbonate composition has
a Vicat B120 softening temperature of at least 150° C. as measured according to ISO 306,
an Izod notched impact strength of greater than or equal to 10 kiloJoule per square meter as measured at 23° C. according to ISO 180/1 A, and
a flame test rating of
V1 as measured according to UL-94 at 0.8 millimeter thickness, and
V0 as measured according to UL-94 at 1.2 millimeter thickness.

11. The article of claim 1, wherein the article is a molded article, a thermoformed article, an extruded film, an extruded sheet, a foamed article, a layer of a multi-layer article, a substrate for a coated article, or a substrate for a metallized article.

12. The article of claim 10, wherein the article is a molded housing.

13. The article of claim 12, wherein the article is an electrical circuit housing.

14. A method for forming the article of claim 1, comprising molding, casting, or extruding the article.
